(19) United States
(12) Patent Application Publication
(10) Pub. No.: US 2026/0126826 A1
(43) Pub. Date: May 7, 2026

(54) COMPACT HIGH FREQUENCY CLOCK GENERATION

(71) Applicant: Ciena Corporation, Hanover, MD (US)

(72) Inventors: Jerry Yee-Tung Lam, Markham (CA); Douglas Stuart McPherson, Ottawa (CA); Yuriy Greshishchev, Ottawa (CA)

(73) Assignee: Ciena Corporation, Hanover, MD (US)

(21) Appl. No.: 18/934,571

(22) Filed: Nov. 1, 2024

(51) Int. Cl. G06F 1/06

(52) U.S. Cl. CPC G06F 1/06

(57) ABSTRACT

Described herein are apparatus and methods for compact high frequency clock generation. A high frequency clock generation circuit includes a differential frequency doubler configured to generate a differential F_{S}/2 frequency clock from a differential F_{S}/4 frequency clock using two input clock phases, and a multistage clock driver configured to at least correct asymmetry of the differential F_{S}/2 frequency clock generated by the differential frequency doubler.

### TECHNICAL FIELD

This disclosure relates to digital to electronic circuits.

### BACKGROUND

The need for high-speed and high-performance electronic circuits is ever increasing. For example, the need for high-speed and high-performance digital to analog converters (DACs) in optical transceivers grows as the data rate in optical coherent modems increases. High-speed and high-performance DACs require high frequency clocks to convert a wide bus of parallel input data into a single high speed analog signal. However, the capacity of semiconductor technologies optimized for high-speed digital signal processing and data processing is lacking in terms of speed of operation, precision in timing, output linearity, and frequency response. Moreover, even if the technology is capable, the circuitry can be complex, occupy a larger portion of area, and have high power consumption.

### SUMMARY

Described herein are apparatus and methods for compact high frequency clock generation.

In an implementation, a high frequency clock generation circuit includes a differential frequency doubler configured to generate a differential F_{S}/2 frequency clock from a differential F_{S}/4 frequency clock using two input clock phases, and a multistage clock driver configured to at least correct asymmetry of the differential F_{S}/2 frequency clock generated by the differential frequency doubler.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a block diagram of an example of a high frequency clock generation circuit in accordance with embodiments of this disclosure.

FIG. 2 is a block diagram of an example of a differential frequency doubler circuit in accordance with embodiments of this disclosure.

FIG. 3 is a block diagram of an example of a multi-stage high frequency clock driver circuit in accordance with embodiments of this disclosure.

FIG. 4 is a flowchart of an example technique for high frequency clock generation in accordance with embodiments of this disclosure.

### DETAILED DESCRIPTION

Reference will now be made in greater detail to embodiments of the invention, examples of which are illustrated in the accompanying drawings. Wherever possible, the same reference numerals will be used throughout the drawings and the description to refer to the same or like parts.

As used herein, the terminology “computer” or “computing device” includes any unit, or combination of units, capable of performing any method, or any portion or portions thereof, disclosed herein. The computer or computing device may include a processor.

As used herein, the terminology “processor” indicates one or more processors, such as one or more special purpose processors, one or more digital signal processors, one or more microprocessors, one or more controllers, one or more microcontrollers, one or more application processors, one or more central processing units (CPU)s, one or more graphics processing units (GPU)s, one or more digital signal processors (DSP)s, one or more application specific integrated circuits (ASIC)s, one or more application specific standard products, one or more field programmable gate arrays, any other type or combination of integrated circuits, one or more state machines, or any combination thereof.

As used herein, the terminology “memory” indicates any computer-usable or computer-readable medium or device that can tangibly contain, store, communicate, or transport any signal or information that may be used by or in connection with any processor. For example, a memory may be one or more read-only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the term “application” refers generally to a unit of executable software that implements or performs one or more functions, tasks, or activities. The unit of executable software generally runs in a predetermined environment and/or a processor.

As used herein, the terminology “determine” and “identify,” or any variations thereof includes selecting, ascertaining, computing, looking up, receiving, determining, establishing, obtaining, or otherwise identifying or determining in any manner whatsoever using one or more of the devices and methods are shown and described herein.

As used herein, the terminology “example,” “the embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is unless specified otherwise, or clear from context, “X includes A or B” is intended to indicate any of the natural inclusive permutations. That is if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

Further, the figures and descriptions provided herein may be simplified to illustrate aspects of the described embodiments that are relevant for a clear understanding of the herein disclosed processes, machines, and/or manufactures, while eliminating for the purpose of clarity other aspects that may be found in typical similar devices, systems, and methods. Those of ordinary skill may thus recognize that other elements and/or steps may be desirable or necessary to implement the devices, systems, and methods described herein. However, because such elements and steps do not facilitate a better understanding of the disclosed embodiments, a discussion of such elements and steps may not be provided herein. However, the present disclosure is deemed to inherently include all such elements, variations, and modifications to the described aspects that would be known to those of ordinary skill in the pertinent art in light of the discussion herein.

Coherent optical communications links and technologies operating at high baud rates need DACs capable of operating at a sampling frequency or rate (F_{S}), for example, of over 200 GS/s rate. These high-speed and high-performance DACs require high frequency clocks to convert a wide bus of parallel input data into a single high speed analog signal.

Described herein are high frequency clock generation circuits and methods for compact high frequency clock generation. In implementations, a high frequency clock generation circuit generates a F_{S}/2 clock using an 8-phase F_{S}/16 clock (generated by a low noise injection locked 8-phase ring oscillator). The clock generation circuit uses an 8-push frequency quadrupler to create a differential F_{S}/4 clock, followed by a 2-push frequency doubler with cross coupling using 2 input clock phases to generate the differential F_{S}/2 clock. The last circuit achieves the equivalent of an output of a 4-push frequency doubler with 2 phases. Only 2 phases are available due to a frequency limit of the ring oscillator as 4 phases would require an 8-phase ring oscillator at F_{S}/8 or a 16-phase ring oscillator at F_{S}/16, which requires too small a phase delay between the clock phases that can be implemented.

In implementations, the frequency doubler can reach reasonable over 100 GHz power levels and is able to create 2 F_{S}/2 output phases, even when driven by 2 F_{S}/4 input phases. In implementations, the over 100 GHz frequency doubler achieves a differential phase output using a 2-push circuit connected to a cross-coupled pair circuit. The output of the cross-coupled pair circuit drives a multi-turn transformer with a 2-turn output coil to further improve the differential output. This allows both turns to fit in a small area with sufficiently low self-capacitance to avoid reducing the self-resonant frequency too low. The multi-turn transformer provides the primary and secondary inductive ratios needed for power matching, while fitting in a compact area and while still having a high quality factor.

In implementations, the differential mode of the F_{S}/2 clock is improved along with clock amplitude and power level by using four (4) transformer coupled gain stages using common source cascode amplifiers in a multi-stage clock driver circuit. The first stage of the multi-stage clock driver circuit uses a cross coupled pair to improve impedance matching, increase gain, and improve differential generation. The second two stages of the multi-stage clock driver circuit are gain stages to increase the clock power level. The last stage of the multi-stage clock driver circuit uses a low gain amplifier designed to be operated in the saturation gain levels in order to limit output power variability to deliver consistent clock levels. The final stage is designed to operate heavily in the non-linear region.

In implementations, the power amplifier circuit uses cascode gain circuits with transformer matching networks and is able to achieve sufficient power gain, even at F_{S}/2 (e.g., over 100 GHz). The transformers provide a high-Q factor, fit in a practical area, can achieve close to ideal impedance match with capacitive input/outputs, and provide separate ports for DC biasing. Resistors placed on the gate side transformer center taps can implement high common-mode gain rejection with minimal impact on the differential gain or the noise.

Compared to conventional clock tree design using inverters or peaked CML buffers, this structure achieves much higher gain and operates at a much higher clock rate. Compared to amplifiers used in mm-wave RF applications, the circuit is implemented in a compact space that is in a heavily area restricted space, and delivers consistent output swing.

Described herein is a compact high frequency sub-Terahertz clock generation circuit. In implementations, the compact high frequency sub-Terahertz clock generation circuit can be used with a variety of electronic circuits.

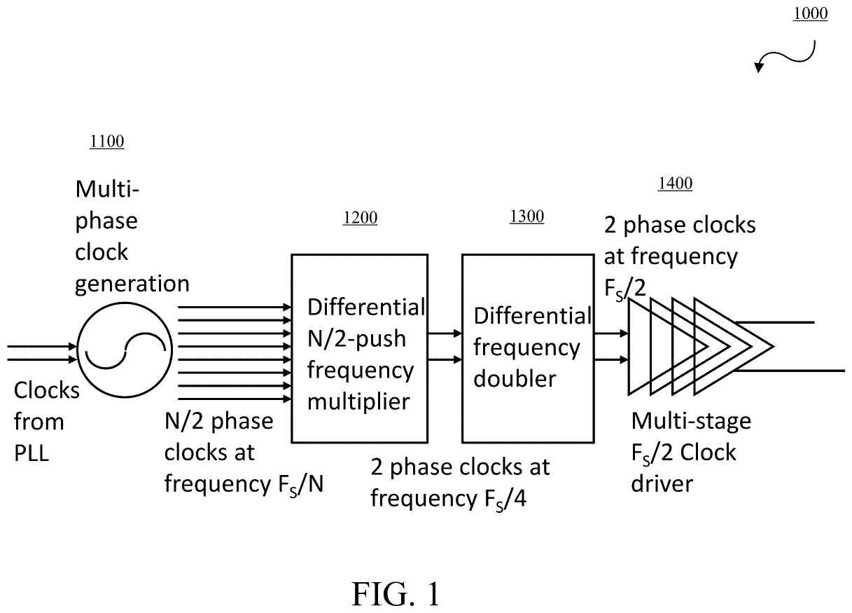

FIG. 1 is a block diagram of an example of a high frequency clock generation circuit 1000 in accordance with embodiments of this disclosure.

The clock generation circuit 1000 includes a multiphase clock generation circuit 1100, a differential N/2-push frequency multiplier 1200, a differential frequency doubler 1300, and a multistage F_{S}/2 clock driver 1400. The multiphase clock generation circuit 1100 can generate N/2 phase clocks at a F_{S}/N clock frequency. In implementations, N can be 16. In implementations, the multiphase clock generation circuit 1100 is a low noise injection locked 8-phase ring oscillator. The differential N/2-push frequency multiplier 1200 can generate a differential F_{S}/4 frequency clock with 2 phase clocks from the N/2 phase clocks. The differential frequency doubler 1300 can generate a differential F_{S}/2 frequency clock from the differential F_{S}/4 frequency clock using only 2 input clock phases. The clock generation step achieves the equivalent output of a 4-push frequency doubler with only 2 phases. Only 2 phases are available due to a frequency limit of the ring oscillator, where 4 phases would require an 8-phase ring oscillator at 28 GHz (F_{S}/8) or a 16-phase ring oscillator at 14 GHz (F_{S}/16), which would require too small a phase delay between the clock phases than can be implemented. The multistage F_{S}/2 clock driver 1400 improves the differential mode, clock amplitude, and power level of the differential F_{S}/2 frequency clock.

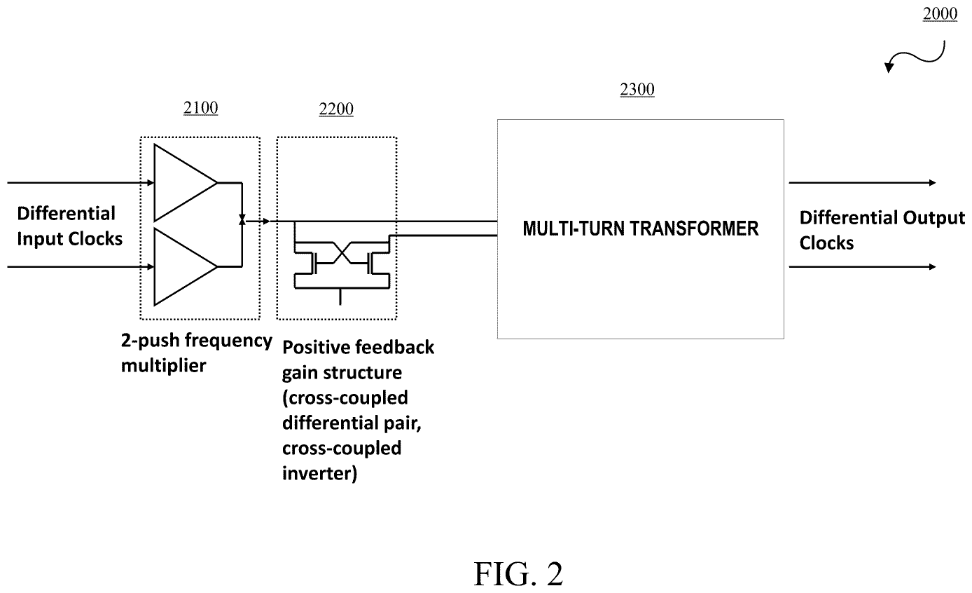

FIG. 2 is a block diagram of an example of a differential frequency doubler circuit 2000 in accordance with embodiments of this disclosure. The differential frequency doubler circuit 2000 can be the differential frequency doubler 1300 of FIG. 1. The differential frequency doubler circuit 2000 includes a 2-push frequency multiplier 2100 connected to a positive feedback gain structure 2200, which in turn is connected to a multiturn balun or transformer 2300.

The 2-push frequency multiplier 2100 can generate one phase of a F_{S}/2 frequency clock from the differential F_{S}/4 frequency clock. The positive feedback gain structure 2200 can generate a second phase of the F_{S}/2 frequency clock. In implementations, the positive feedback gain structure 2200 can be a cross-coupled differential pair, a cross-coupled inverter, or other similar structure. The resulting clock output can have input/output drive asymmetry. The multiturn balun or transformer 2300 can provide a relatively large 2^{nd} harmonic generation, good coupling to a gain stage in the multistage F_{S}/2 clock driver 1400, and differential correction. That is, the multiturn balun or transformer 2300 can correct the differential F_{S}/2 frequency clock.

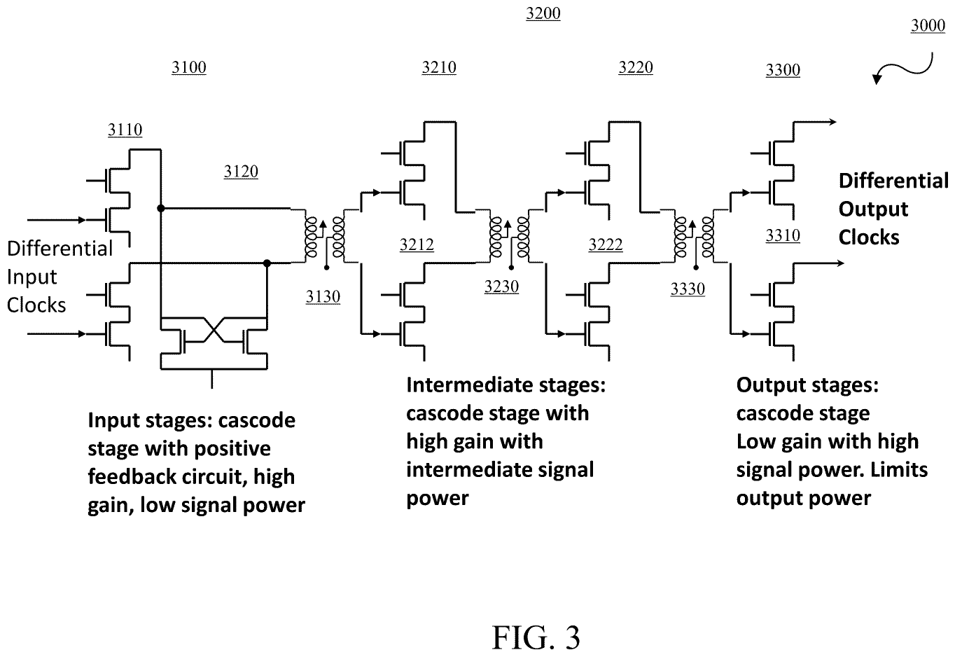

FIG. 3 is a block diagram of an example of a multi-stage high frequency clock driver circuit 3000 in accordance with embodiments of this disclosure. The multi-stage high frequency clock driver circuit 3000 can be the multi-stage high frequency clock driver circuit 1400 of FIG. 1. The multi-stage high frequency clock driver circuit 3000 includes a first or input stage 3100, an intermediate stage 3200, and an output stage 3300. The intermediate stage 3200 includes a first intermediate stage 3210 and a second intermediate stage 3220. The first or input stage 3100 is connected via a transformer 3130 to the first intermediate stage 3210, the first intermediate stage 10210 is connected via a transformer 3230 to the second intermediate stage 10220, and the second intermediate stage 3220 is connected via a transformer 3330 to the output stage 3300. The transformers 3130, 3230, and 3330 allow for compact impedance matching and AC coupling with low loss and high Q. The transformers 3130, 3230, and 3330 maximize Q and k, are single turn with large output diameter for both primary and secondary side, and have L1/L2 ratio achieved with line width.

The first or input stage 3100 includes a cascode circuit 3110 connected to a positive feedback circuit 3120, which collectively provide a low signal power differential F_{S}/2 frequency clock. In implementations, the cascode circuit 3110 is implemented using common source cascode amplifiers. In implementations, the positive feedback circuit 3120 is a cross-coupled pair. The cascode circuit 3110 provides high gain to the input differential F_{S}/2 frequency clock. The positive feedback circuit 3120 provides improved impedance matching, increased gain, and improved differential generation. That is, the positive feedback circuit 3120 also corrects the asymmetry in the input differential F_{S}/2 frequency clock.

The first intermediate stage 3210 includes a cascode circuit 3212 and the second intermediate stage 3220 includes a cascode circuit 3222. In implementations, the cascode circuit 3212 and 3222 are implemented using common source cascode amplifiers. The first intermediate stage 3210 and the second intermediate stage 3220 provide high gain with an intermediate signal power differential F_{S}/2 frequency clock.

The output stage 3300 includes a cascode circuit 3310. In implementations, the cascode circuit 3310 is implemented using common source cascode amplifiers. The cascode circuit 3310 is operated at saturation gain levels in order to limit output power variability and deliver consistent clock levels. The output stage 3300 operates heavily or mostly in the non-linear region. The output stage 3300 provides low gain with high signal power differential F_{S}/2 frequency clock.

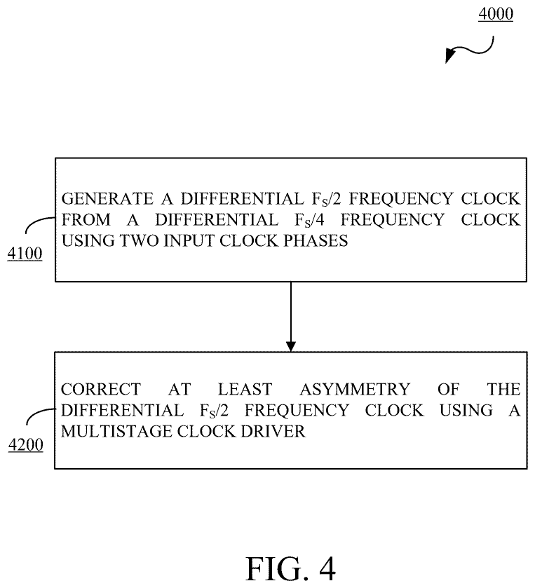

FIG. 4 is a flowchart of an example method 4000 for high frequency clock generation in accordance with embodiments of this disclosure. The method 4000 includes: generating 4100 a differential F_{S}/2 frequency clock from a differential F_{S}/4 frequency clock using two input clock phases; and correcting 4200 at least asymmetry of the differential F_{S}/2 frequency clock using a multistage clock driver. The method 4000 can be implemented by the circuits and components therein of FIGS. 1-3, as appropriate and applicable.

The method 4000 includes generating 4100 a differential F_{S}/2 frequency clock from a differential F_{S}/4 frequency clock using two input clock phases. The differential F_{S}/2 frequency clock is generated from a differential F_{S}/4 frequency clock using only two input clock phases at a differential frequency doubler.

The method 4000 includes correcting 4200 at least asymmetry of the differential F_{S}/2 frequency clock using a multistage clock driver. The asymmetry of the differential F_{S}/2 frequency clock generated by the differential frequency doubler can be corrected at a multistage clock driver. The multistage clock driver can apply multiple gain stages to the differential F_{S}/2 frequency clock generated by the differential frequency doubler to generate the differential F_{S}/2 frequency clock.

Although some embodiments herein refer to methods, it will be appreciated by one skilled in the art that they may also be embodied as a system or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “processor,” “device,” or “system.” Furthermore, aspects of the present invention may take the form of a computer program product embodied in one or more the computer readable mediums having the computer readable program code embodied thereon. Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to CDs, DVDs, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

While the disclosure has been described in connection with certain embodiments, it is to be understood that the disclosure is not to be limited to the disclosed embodiments but, on the contrary, is intended to cover various modifications, combinations, and equivalent arrangements included within the scope of the appended claims, which scope is to be accorded the broadest interpretation so as to encompass all such modifications and equivalent structures as is permitted under the law.

What is claimed is:

1. A high frequency clock generation circuit, comprising:
a differential frequency doubler configured to generate a differential F_{S}/2 frequency clock from a differential F_{S}/4 frequency clock using two clock phases as inputs; and
a multistage clock driver configured to at least correct asymmetry of the differential F_{S}/2 frequency clock generated by the differential frequency doubler.

2. The high frequency clock generation circuit of claim 1, further comprises
a multiphase clock generation circuit configured to generate N/2 phase clocks at a F_{S}/N clock frequency.

3. The high frequency clock generation circuit of claim 2, wherein the multiphase clock generation circuit is a low noise injection locked 8-phase ring oscillator.

4. The high frequency clock generation circuit of claim 2, further comprises
a differential N/2-push frequency multiplier configured to generate the differential F_{S}/4 frequency clock with the two phase clocks from the N/2 phase clocks.

5. The high frequency clock generation circuit of claim 1, wherein the differential frequency doubler further comprises
a 2-push frequency multiplier configured to generate one clock phase of the differential F_{S}/2 frequency clock from the differential F_{S}/4 frequency clock; and
a positive feedback gain structure configured to generate a second clock phase of the differential F_{S}/2 frequency clock, wherein a resulting differential F_{S}/2 frequency clock has input and output drive asymmetry.

6. The high frequency clock generation circuit of claim 1, wherein the multistage clock driver further comprises
an input stage configured to correct the asymmetry of the differential F_{S}/2 frequency clock generated by the differential frequency doubler and apply a high gain to output a low signal power differential F_{S}/2 frequency clock;
an intermediate stage configured to apply two stages of high gain to the low signal power differential F_{S}/2 frequency clock and output an intermediate signal power differential F_{S}/2 frequency clock; and
an output stage configured to apply a low gain to the intermediate signal power differential F_{S}/2 frequency clock to generate a high signal power differential F_{S}/2 frequency clock.

7. The high frequency clock generation circuit of claim 6, wherein the multistage clock driver further comprises
a first transformer configured to connect the input stage to the intermediate stage;
a second transformer configured to connect the two stages of the intermediate stage; and
a third transformer configured to connect the intermediate stage to the output stage,
wherein the first transformer, the second transformer, and the third transformer are configured to provide compact impedance matching and maximize Q.

8. The high frequency clock generation circuit of claim 6, wherein the input stage further comprises
a cascode circuit configured to provide high gain to the differential F_{S}/2 frequency clock; and
a positive feedback circuit connected to the cascode circuit and to the intermediate stage, the positive feedback circuit configured to correct the asymmetry in the differential F_{S}/2 frequency clock.

9. The high frequency clock generation circuit of claim 6, wherein the output stage further comprises
a cascode circuit configured to operate at saturation gain levels in order to limit output power variability and deliver consistent clock levels.

10. A method for high frequency clock generation, comprising:
generating, at a differential frequency doubler, a differential F_{S}/2 frequency clock from a differential F_{S}/4 frequency clock using two input clock phases; and
correcting, at a multistage clock driver, asymmetry of the differential F_{S}/2 frequency clock generated by the differential frequency doubler.

11. The method for high frequency clock generation of claim 10, further comprises
applying, at the multistage clock driver, multiple gain stages to the differential F_{S}/2 frequency clock generated by the differential frequency doubler to generate a low signal power differential F_{S}/2 frequency clock.

12. The method for high frequency clock generation of claim 10, further comprises
generating N/2 phase clocks at a F_{S}/N clock frequency; and
generating, by a differential N/2-push frequency multiplier, the differential F_{S}/4 frequency clock with the two phase clocks from the N/2 phase clocks.

13. The method for high frequency clock generation of claim 10, further comprises
generating, by a 2-push frequency multiplier, one clock phase of the differential F_{S}/2 frequency clock from the differential F_{S}/4 frequency clock; and
generating, by a positive feedback gain structure, a second clock phase of the differential F_{S}/2 frequency clock, wherein a resulting differential F_{S}/2 frequency clock has input and output drive asymmetry.

14. A device, comprising:
a multiphase clock generation circuit configured to generate N/2 phase clocks at a F_{S}/N clock frequency;
a differential N/2-push frequency multiplier configured to generate differential F_{S}/4 frequency clock with two phase clocks from the N/2 phase clocks;
a differential frequency doubler configured to generate a differential F_{S}/2 frequency clock from the differential F_{S}/4 frequency clock using the two clock phases as inputs; and
a multistage clock driver configured to at least correct asymmetry of the differential F_{S}/2 frequency clock generated by the differential frequency doubler.

15. The device of claim 14, wherein the multiphase clock generation circuit is a low noise injection locked 8-phase ring oscillator.

16. The device of claim 14, wherein the differential frequency doubler further comprises
a 2-push frequency multiplier configured to generate one clock phase of the differential F_{S}/2 frequency clock from the differential F_{S}/4 frequency clock; and
a positive feedback gain structure configured to generate a second clock phase of the differential F_{S}/2 frequency clock, wherein a resulting differential F_{S}/2 frequency clock has input and output drive asymmetry.

17. The device of claim 14, wherein the multistage clock driver further comprises
an input stage configured to correct the asymmetry of the differential F_{S}/2 frequency clock generated by the differential frequency doubler and apply a high gain to output a low signal power differential F_{S}/2 frequency clock;
an intermediate stage configured to apply two stages of high gain to the low signal power differential F_{S}/2 frequency clock and output an intermediate signal power differential F_{S}/2 frequency clock; and
an output stage configured to apply a low gain to the intermediate signal power differential F_{S}/2 frequency clock to generate a high signal power differential F_{S}/2 frequency clock.

18. The device of claim 17, wherein the multistage clock driver further comprises
a first transformer configured to connect the input stage to the intermediate stage;
a second transformer configured to connect the two stages of the intermediate stage; and
a third transformer configured to connect the intermediate stage to the output stage,
wherein the first transformer, the second transformer, and the third transformer are configured to provide compact impedance matching and maximize Q.

19. The device of claim 17, wherein the input stage further comprises
a cascode circuit configured to provide high gain to the differential F_{S}/2 frequency clock; and
a positive feedback circuit connected to the cascode circuit and to the intermediate stage, the positive feedback circuit configured to correct the asymmetry in the differential F_{S}/2 frequency clock.

20. The device of claim 19, wherein the output stage further comprises
a cascode circuit configured to operate at saturation gain levels in order to limit output power variability and deliver consistent clock levels.
